(19) United States
(12) Patent Application Publication
(10) Pub. No.: US 2015/0289463 A1
(43) Pub. Date: Oct. 15, 2015

(54) HYDROPONIC GROW SYSTEM

(71) Applicant: David Moriarty, Macomb, MI (US)

(72) Inventor: David Moriarty, Macomb, MI (US)

(21) Appl. No.: 14/680,623

(22) Filed: Apr. 7, 2015

Related U.S. Application Data
(60) Provisional application No. 61/977,501, filed on Apr. 9, 2014.

(51) Int. Cl. A01G 31/02; A01G 27/00

(52) U.S. Cl. CPC A01G 31/02; A01G 27/003

(57) ABSTRACT

A hydroponic grow system for growing plants. The system includes a main reservoir, at least one plant reservoir that includes a spray head and a fill pump. The fill pump fills the at least one plant reservoir by pumping a water and nutrient mixture into the plant reservoirs through a spray head. A controller drains the water and nutrient mixture from the at least one plant reservoir and a control reservoir in a predetermined manner such that a siphon is created to provide a flow of the water and nutrient mixture to the at least one plant reservoir.

### CROSS-REFERENCE TO RELATED APPLICATIONS

This application claims the benefit of the priority date of U.S. Provisional Patent Application Ser. No. 61/977,501, titled HYDROPONIC GROW SYSTEM, filed Apr. 9, 2014.

### BACKGROUND OF THE INVENTION

1. Field of the Invention

This invention relates generally to hydroponic grow systems and, more particularly, to a hydroponic grow system that employs spray heads and a main reservoir that is easy to use and provides high plant yields.

2. Discussion of the Related Art

Various hydroponic grow systems are used to grow plants. For example, aeroponic grow systems spray the roots of plants in growth containers with a fine oxygenated mist of a water and nutrient mixture. These systems typically grow healthy plants, however problems with these systems include pump failure, spray head clogging, roots plugging the spray heads, power outages, etc. If any of these problems occur for even a short period of time the plants can start to dehydrate and eventually die off. Aeroponic grow systems are ideal for cloning and starting new seedlings because in these situations the root masses of the plants are small, thereby minimizing the potential for spray head clogging.

Ebb and flow grow systems are commonly used among hobbyists and small to medium size indoor growth facilities. The water and nutrient mixture is stored in a main reservoir and is pumped into a control reservoir that feeds the water and nutrient mixture to several plant containers. The plant containers are filled to a preset level and the level is maintained for a period of time by a timer circuit in a main controller. Once the fill cycle timer has expired a drain pump turns on and pumps the water and nutrient mixture back into the main reservoir, thereby draining all of the plant containers. Failures with controllers, pumps, switches, etc. as well as electrical outages can cause serious problems for this type of grow system. Another problem with these types of grow systems are a lack of sufficient fresh water and nutrient exchange because of plant roots clogging the fill/drain line at the bottom of the plant containers, thereby preventing optimal flow of the water and nutrient mixture.

Deep water culture (also known as under current) grow systems are presently the most popular hydroponic grow system on the market. These systems are attractive because they have the potential for very good crop yields. Deep water culture systems include individual plant containers that are connected in series with a common tube plenum. The plenum is connected to a circulation pump that draws a water and nutrient mixture through all of the individual plant containers and pushes the mixture into a control reservoir. The design of deep water culture systems is intended to provide constant water and nutrient flow to each of the plant containers. Problems associated with these systems are the same as those discussed above, i.e., electrical, controller and pump failures.

In addition, when the root mass in the one or more plant containers gets too large, the root mass will prevent the circulation pump from drawing the water and nutrient mixture evenly and may cause pump cavitation. Furthermore, deep water culture grow systems are labor intensive because the constant circulation of the water and nutrient mixture employed by this system makes it impossible to make pH or nutrient adjustments without first evacuating the entire system into an isolated reservoir only to pump all of the adjusted solution back into the system. Because a typical twelve plant container system contains more than 150 gallons of water, making changes such as nutrient adjustments is a substantial task. Additionally, each of the plant containers requires aeration from air stones and a sizable air pump to aerate the root mass because it is constantly submerged. A power outage may cease the flow of air to the roots, as well as circulation of the water and nutrient mixture, which could cause rapid deterioration of the roots.

Flood and drain growth systems include plants that are situated on top of a table or placed inside gutters that hold water. A controller/timer turns on a fill pump which floods the table or gutters with a water and nutrient mixture, and then overflows back into the control reservoir. Once the timer has expired, the system stops pumping the water and nutrient mixture into the table or the gutters. The water and nutrient mixture is then drained. This type of system has all of the same potential electrical failures described above in the other systems, and also has a large percentage of evaporation, particularly in open table configurations. While this is a simple approach to hydroponic gardening, flood and drain grow systems can be cumbersome because of the limited table top area. These systems are better suited for small plants only.

Drip emitting grow systems are made using a simple design and, as the name implies, drip a water and nutrient mixture onto growth medium and/or plant roots in a constant or a pulsed manner using a timer/controller. These types of grow systems are preferred in large scale indoor greenhouses because of their ease of use. Plants in these systems are typically rooted inside bags that lay inside gutters and the drip emitter tubes are punched into the root bags to supply the water and nutrient mixture. This method works well for certain produce and is typically well-suited for small to medium size plants.

While the grow systems above are able to produce healthy plants, there is a need in the art for a grow system that is capable of providing healthy plants with a high yield that is simple to maintain.

### SUMMARY OF THE INVENTION

In accordance with the teachings of the present invention, a hydroponic grow system for growing plants is disclosed. The system includes a main reservoir, at least one plant reservoir that includes a spray head and a fill pump. The fill pump fills the at least one plant reservoir by pumping a water and nutrient mixture into the plant reservoirs through a spray head. A controller drains the water and nutrient mixture from the at least one plant reservoir and a control reservoir in a predetermined manner such that a siphon is created to provide a flow of the water and nutrient mixture to the at least one plant reservoir.

Additional features of the present invention will become apparent from the following description and appended claims, taken in conjunction with the accompanying drawings.

### BRIEF DESCRIPTION OF THE DRAWINGS

FIG. 1 is a schematic block diagram of a hydroponic grow system;

FIG. 2 is an exploded view of a spray head of the hydroponic grow system; and

FIG. 3 is a schematic block diagram showing various phases of a hydroponic grow system.

### DETAILED DESCRIPTION OF THE EMBODIMENTS

The following discussion of the embodiments of the invention directed to a hydroponic grow system is merely exemplary in nature, and is in no way intended to limit the invention or its applications or uses.

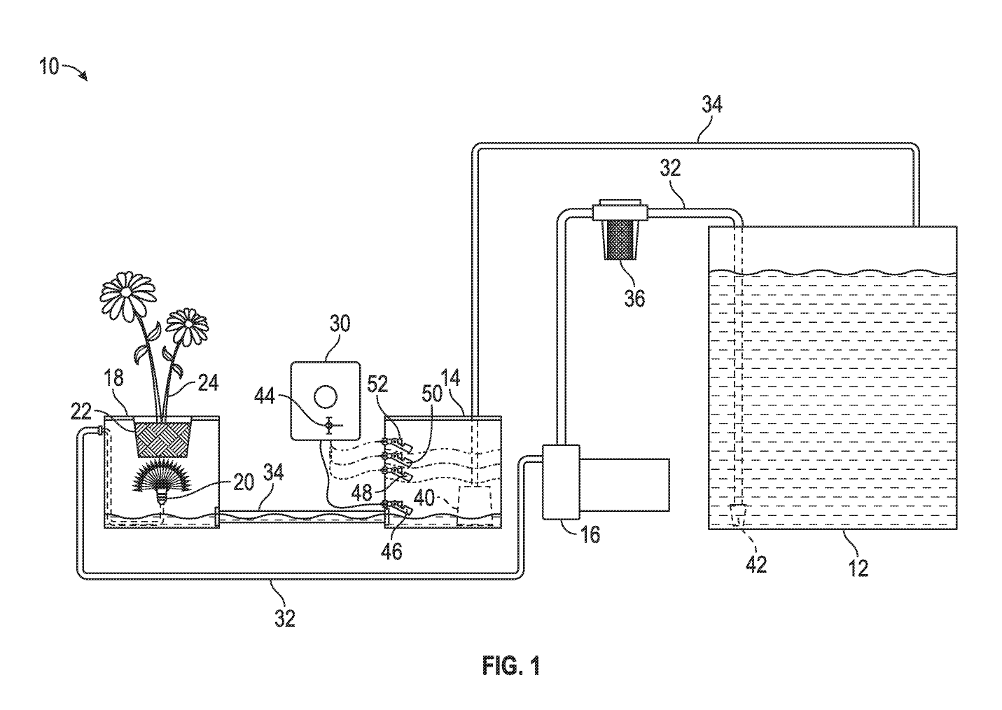

FIG. 1 is a schematic block diagram of a hydroponic grow system 10 that includes a main reservoir 12, a control reservoir 14 and a pump 16. The pump 16 is a high pressure/high volume type of pump, for example, a pump that is capable of delivering the required pressure and volume to prevent roots from clogging. A water and nutrient mixture is pumped from the main reservoir 12 into one or more plant reservoirs 18 through a line 32. The water and nutrient mixture enters the one or more plant reservoirs 18 through a spray head 20 that is located within each of the one or more plant reservoirs 18. The water and nutrient mixture is sprayed upward into a root mass 22 of a plant 24 using the spray head 20. A system controller 30 causes the water and nutrient mixture to fill in the one or more plant reservoirs 18 using the spray head 20 until a preset water level has been achieved.

The main reservoir 12 includes a foot valve 42 that is connected to the line 32. The foot valve 42 may be, for example, a spring loaded valve that includes a strainer or screen on the outer surface (not shown). The foot valve 42 allows for intake of the water and nutrient mixture from the main reservoir 12 to the line 32 when the pump 16 is operating. When the pump 16 is not operating the foot valve 42 does not allow the water and nutrient mixture to backflow from the line 32 to the main reservoir 12.

The system controller includes a knob 44 for adjusting the maximum water and nutrient mixture height in the plant reservoir 18. In particular, switches, such as float switches 48, 50 and 52, are in electrical communication with the controller 30 such that when the knob 44 is set at a low setting the switch 48 will be used to control the height of the water and nutrient mixture. When the knob 44 is set at a medium setting the switch 50 will be used to control the height, and when the knob 44 is set at a high setting the switch 52 will be used. Although three settings of the knob 44 and three height controlling switches 48, 50 and 52 are shown, any number of settings and switches may be used

A drain switch 46 is also in electrical communication with the controller 30 to stop the drain pump 40 when the water and nutrient mixture reaches a desired height. While the controller 30 described is a controller that uses an electromechanical timer, relays and switches, any controller may be used to control the system 10, such as the controller described in application Ser. No. 13/953,604 entitled “Hydroponic Guardian System”, filed by the same inventive entity on Jul. 29, 2013 and incorporated herein by reference. Water also fills the control reservoir 14 through the line 34 that is between the one or more plant reservoirs 18 and the control reservoir 14. The water and nutrient mixture is maintained in the one or more plant reservoirs 18 for a predetermined period of time and then the one or more plant reservoirs 18 and the control reservoir 14 are drained back into the main reservoir 12 using a drain pump 40. The cycle repeats in a predetermined manner. For example, the controller 30 may be programmed to provide a 15 minute fill cycle and a 30 minute drain cycle, although any fill and drain cycle may be selected.

Because the system 10 includes the main reservoir 12, a user may adjust pH and nutrient composition without shocking or stunting the plants 24. An inline filter 36 upstream of the pump 16 prevents clogging and/or spray head contamination. The pump 16 is powerful enough to cause the spray from the spray head 20 to force the root mass 22 away from the spray head 20, thereby preventing the root mass 22 from clogging the spray head 20.

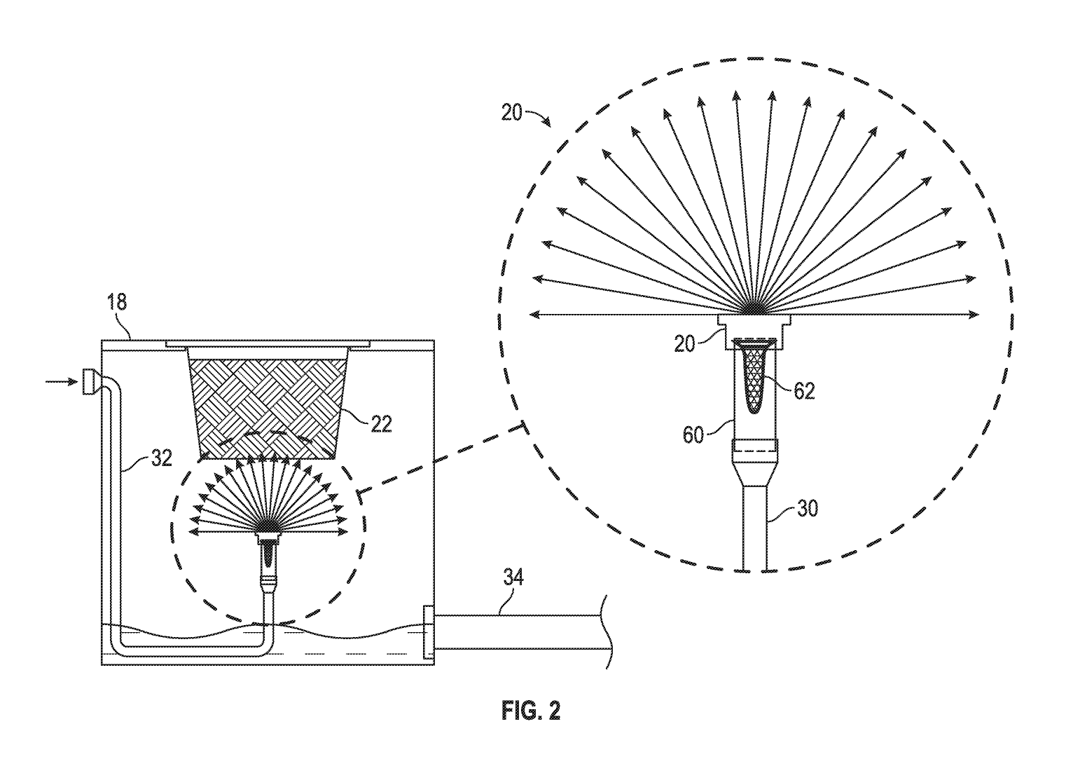

FIG. 2 is an exploded view of the spray head 20. The height of the spray head 20 may be adjusted using an adapter 60. The height of the adapter 60 may be any suitable height. The adapter 60 may be made of any suitable material, for example, PVC. The adapter 60 may be connected to the line 32 and the spray head 20 in various ways, for example, by using fittings. The pressure of the water and nutrient mixture is adjustable using a pressure relief valve. Because the height, pressure, and duration of operation of the spray head 20 may be varied, a wide variety of plants may be grown using the system 10. The spray head 20 may also include a filter 62 to prevent clogging by trapping small sediment and particles.

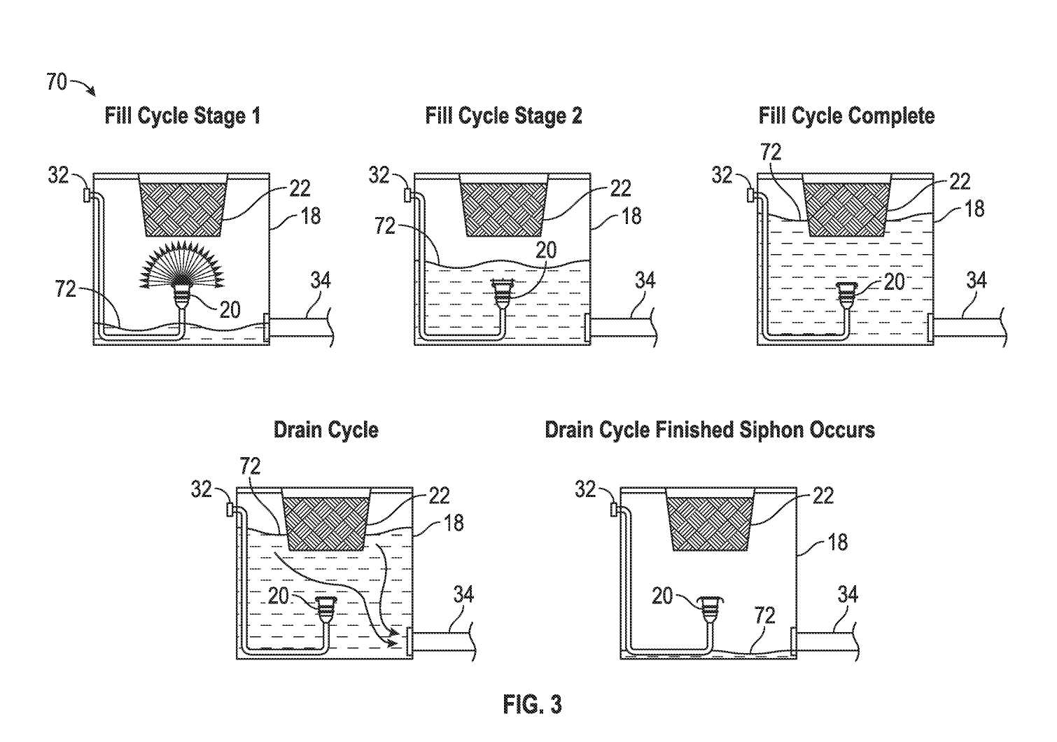

FIG. 3 is a schematic block diagram of various phases 70 of the hydroponic system 10, where like elements use the same reference numerals as FIG. 1. During a Fill Cycle Stage 1, the high pressure pump 16 activates and the water and nutrient mixture is sprayed up into the root mass 22 using the spray head 20. The control reservoir 14 simultaneously fills to the same level as the plant container 18 during this stage. Because the water and nutrient mixture level is below the spray head 20 as shown by a line 72, the oxygenated water and nutrient mixture is sprayed upwards towards the root mass 22. Next, during a Fill Cycle Stage 2, the water and nutrient mixture level at the line 72 is above the spray head 20 to thoroughly soak the entire root mass 22.

At a Fill Cycle Complete phase, the water and nutrient mixture at the line 72 has reached the highest setting in the plant containers 18 and the control reservoir 14. At this stage the plant container 18 remains at the level shown by the line 72 for a predetermined period of time to ensure that the root mass 22 is thoroughly soaked. Next, a Drain Cycle begins when a fill timer of the controller 30 has expired according to the predetermined period of time. During this stage the drain pump 40 that is located inside the control reservoir 14 pumps the water and nutrient mixture back into the main reserve 12, causing all of the plant containers 18 to drain the water and nutrient mixture. At a Drain Cycle Finished Siphon Occurs stage the control reservoir 14 has emptied into the main reservoir 12. All of the plant containers 18 are empty or near empty as shown by the line 72. However, an auto siphon effect occurs due to water head pressure inside the main reservoir that delivers a constant water and nutrient mixture to the plants via a gentle flow through the spray head 20. This effect also acts as an auto fill in the event of a power failure. A back up drain pump (not shown) may be added using a guardian control system as described in application Ser. No. 13/953,604 discussed above.

The system 10 combines the aeration capability of aeroponic grow systems with the fill and hold capability seen in ebb and flow and flood and drain grow systems. The auto siphon effect occurs because the system 10 is designed to allow for a siphon effect to occur. In particular, the head pressure of the main reservoir 12 in combination with the lack of a vacuum breaker in the fill side of the pump 16 and the line 32 creates a siphon as described above. The system 10 reduces harvesting times by as much as 4-7 days in a typical 57-60 day cycle. The plants 24 grown using the system 10 grow with root systems that are stronger than the root systems of the plants grown using other hydroponic grow systems. Additionally, roots of the plants 24 have multiple stages of main and intermediary root legs through to fine roots, where only fine roots are normally present with hydroponic growing. The improved root health and strength allows for larger and thicker plant trunks and stems comparable to growing outdoors. Because of the strong and enlarged root structure of the plants 24 the stalks of the plants 24 are thicker and sturdier, thereby capable of handling fruit/vegetable weight that is greater than average. The strong and enlarged root structure also allows for improved nutrient uptake throughout the plants vegetative and flowering stages.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A hydroponic grow system comprising:
a main reservoir for holding a water and nutrient mixture;
at least one plant reservoir that is in fluid communication with the main reservoir using a fill line, said at least one plant reservoir including a spray head for spraying the water and nutrient mixture onto a root mass that is in the at least one plant reservoir;
a fill pump in the fill line that pumps the water and nutrient mixture from the main reservoir to the at least one plant reservoir;
a control reservoir in fluid communication with the at least one plant reservoir using a first drain line and in fluid communication with the main reservoir using a second drain line, said control reservoir filling at the same time and up to the same height as the at least one plant reservoir; and
a controller that is programmed to drain the water and nutrient mixture from the at least one plant reservoir and the control reservoir in a predetermined manner such that a siphon is created to provide a flow of the water and nutrient mixture to the at least one plant reservoir in a manner such that a trickle of the water and nutrient mixture is provided through the spray head.

2. The grow system according to claim 1 wherein the spray head is adjustable so that the height of the spray head may be adjusted within the plant reservoir.

3. The grow system according to claim 1 further comprising a pressure valve capable of adjusting the pressure of the spray from the spray head.

4. The grow system according to claim 1 wherein the fill pump is a high pressure/high power pump.

5. The grow system according to claim 1 further comprising one or more float switches that are in electrical communication with the controller such that the height of the water and nutrient mixture in the at least one plant reservoir is controlled.

6. The grow system according to claim 5 wherein the one or more float switches is three float switches.

7. A hydroponic grow system comprising:
a main reservoir that holds a water and nutrient mixture, said main reservoir being accessible by a user such that the water and nutrient mixture may be tested, adjusted and replenished;
a plurality of plant reservoirs that are in fluid communication with the main reservoir using a fill line for each of the plurality of plant reservoirs, wherein each of the plurality of plant reservoirs includes a spray head that is in fluid communication with an end of the fill line such that the spray head is capable of spraying the water and nutrient mixture from the main reservoir onto a root mass that is in each of the plurality of plant reservoirs;
a fill pump that is part of the fill lines between the main reservoir and the plurality of plant reservoirs, said fill pump pumping the water and nutrient mixture from the main reservoir to the plurality of plant reservoirs;
a control reservoir that is in fluid communication with the plurality of plant reservoirs using a plurality of first drain lines and in fluid communication with the main reservoir using a second drain line, said control reservoir filling at the same time and up to the same height as the plurality of plant reservoirs; and
a controller that is programmed to cause the water and nutrient mixture to flow from the main reservoir to the plurality of plant reservoirs and back to the main reservoir from the plurality of plant reservoirs at predetermined time intervals, wherein draining the water and nutrient mixture from the plurality of plant reservoirs and the control reservoir is done such that a siphon is created to provide a flow of the water and nutrient mixture to the plurality of plant reservoirs.

8. The grow system according to claim 7 wherein the spray head is adjustable so that the height of the spray head may be adjusted within each of the plurality of plant reservoirs.

9. The grow system according to claim 7 further comprising a pressure valve capable of adjusting the pressure of the spray from the spray head.

10. The grow system according to claim 7 wherein the fill pump is a high pressure/high power pump.

11. The grow system according to claim 7 further comprising one or more float switches that are in electrical communication with the controller such that the height of the water and nutrient mixture that is in the plurality of plant reservoirs is controlled.

12. The grow system according to claim 11 wherein the one or more float switches is three float switches.

13. The grow system according to claim 7 further comprising a foot valve that allows the water and nutrient mixture to flow from the main reservoir when the fill pump is operating.

14. A hydroponic grow system comprising:
a main reservoir for holding a water and nutrient mixture, said main reservoir being accessible by a user such that the water and nutrient mixture may be tested, adjusted and replenished;
a plurality of plant reservoirs, each including a fill line that is in fluid communication with a main fill line, said main fill line also being in fluid communication with the main reservoir, wherein each of the plurality of plant reservoirs includes a spray head that is in fluid communication with an end of the associated fill line and capable of spraying the water and nutrient mixture from the main reservoir onto a root mass that is in each of the plurality of plant reservoirs;
a fill pump that is part of the main fill line, said fill pump pumping the water and nutrient mixture from the main reservoir to the plurality of plant reservoirs;
a control reservoir that is in fluid communication with the plurality of plant reservoirs using one or more inlet drain lines and that is also in fluid communication with the main reservoir using an outlet drain line, said control reservoir filling at the same time and up to the same height as the plurality of plant reservoirs; and
a controller that is programmed to cause the water and nutrient mixture to fill the plurality of plant reservoirs from the main reservoir up to a predetermined height, said controller further being programmed to cause the water and nutrient mixture to remain in the plurality of plant reservoirs a predetermined period of time and to drain the water and nutrient mixture from the plurality of plant reservoirs back into the main reservoir, wherein draining the water and nutrient mixture back into the main reservoir is done such that a siphon is created to provide a flow of water and nutrient mixture to the plurality of plant reservoirs in a manner such that a trickle of the water and nutrient mixture is provided through the spray head.

15. The grow system according to claim 14 wherein the spray head is adjustable so that the height of the spray head may be adjusted within each of the plurality of plant reservoirs.

16. The grow system according to claim 14 further comprising a pressure valve capable of adjusting the pressure of the spray from the spray head.

17. The grow system according to claim 14 wherein the fill pump is a high pressure/high power pump.

18. The grow system according to claim 14 further comprising one or more float switches that are in electrical communication with the controller such that the height of the water and nutrient mixture that is in the plurality of plant reservoirs is controlled.

19. The grow system according to claim 18 wherein the one or more float switches is three float switches.

20. The grow system according to claim 14 further comprising a foot valve that allows the water and nutrient mixture to flow from the main reservoir when the fill pump is operating.
